(19) United States
(12) Patent Application Publication
(10) Pub. No.: US 2009/0315290 A1
(43) Pub. Date: Dec. 24, 2009

(54) MULTI-DIRECTIONAL CASTER ASSEMBLY

(76) Inventor: Alon Vanounou, Tel Aviv (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(21) Appl. No.: 12/144,959

(22) Filed: Jun. 24, 2008

(51) Int. Cl. B62M 1/00

(52) U.S. Cl. 280/87.042

(57) ABSTRACT

A multi-directional caster assembly comprising a rotatable caster pivotable about a shaft that is pivotally connected to a base and that may be reoriented within a predefined conical volume.

### FIELD OF THE INVENTION

The present invention relates to wheels. More specifically, the present invention relates to a multi-directional caster assembly.

### BACKGROUND OF THE INVENTION

Swivel wheels (also known as casters) are known in the art. Swivel wheels are usually designed to be small enough so they may be attached to the bottom of boxes, carts, chairs, beds, skateboards and other items to be wheeled so that the items can be moved around easily. The swivel wheels are preferably small and light so that they do not occupy much space and are lightweight.

A common swivel wheel is a wheel that is rotatable about a horizontal axis. The wheel holder is made to rotate freely about a vertical axis so that the item to be wheeled to which the wheel is connected may roll to any desired direction. As the item is pushed to a certain direction, the wheel swivels about the vertical axis so as to adapt the direction of movement and then rotates about the horizontal axis as the item is advanced.

Swivel wheels are widely used. One of many such uses is in skateboards.

First skateboards were provided with two pairs of wheels, each pair including two wheels in a substantially parallel arrangement, which were rotatable about a single fixed axis, allowing the skateboard to travel in straight lines only.

The conventional skateboard was first introduced in the 1960's. It includes a rigid board supported by four wheels that are mounted underneath the board.

The conventional skateboard is propelled by pushing with one foot while the other foot remains on the board. Turning the skateboard to the left or to the right direction is carried out by leaning to one side or the other.

Since the 1960's the conventional skateboard has gradually changed and evolved various designs and modifications.

U.S. Pat. No. 7,195,259 (Kang), for instance, discloses a skateboard which is more steerable than the conventional skateboard and which can be accelerated without the rider stamping onto the ground.

Kang's skateboard has a front board, a rear board, a connecting element which interconnect the front board and the rear board in a spaced relationship, at least one caster mounted on the underside of each of the front board and the rear board. The connecting element includes an elastic member so that the connecting element which is elastically twistable by application of twisting or bending force and restores to its original shape when the force is removed.

As disclosed above, Kang proposes a skateboard which is more steerable than the conventional skateboard; however, Kang's skateboard is unidirectional. The caster wheels beneath the skateboard are swivelable about an inclines axis, and therefore tend to remain aligned in one direction, allowing the skateboard to travel only forward but preventing traveling backward.

Therefore, an aim of the present invention is to overcome the above-mentioned limitation and to provide a bidirectional or multidirectional skateboard with enhanced steering ability. More specifically, the proposed design is of a skateboard that allows the rider to easily ride forward or backward at will, or perform a fast change of direction, for example front to back, back to front, and sliding sideways.

A further object of the present invention is to provide a skateboard which allows easy steering and accelerating as well as stability and safety for the rider.

Other objects and advantages of the present invention will become apparent after reading the present specification and reviewing the accompanying drawings.

### SUMMARY OF THE INVENTION

There is thus provided, according to embodiments of the present invention, a multi-directional caster assembly comprising a rotatable caster pivotable about a shaft that is pivotally connected to a base and that may be reoriented within a predefined conical volume.

Furthermore, in accordance with some embodiments of the present invention, the caster comprises a support structure, wherein the shaft includes a forked support pivotally connected to said support structure on which the caster is rotatably mounted, wherein the support structure includes an aperture confining the shaft to move within the aperture.

Furthermore, in accordance with some embodiments of the present invention, the aperture is circular.

Furthermore, in accordance with some embodiments of the present invention, the aperture is oval.

Furthermore, in accordance with some embodiments of the present invention, the caster assembly is incorporated in a skateboard.

Furthermore, in accordance with some embodiments of the present invention, the skateboard comprises a support surface.

Furthermore, in accordance with some embodiments of the present invention, the support surface comprises a single board.

Furthermore, in accordance with some embodiments of the present invention, the support surface comprises two separate boards, wherein the caster assembly is attached to the bottom of each board.

Furthermore, in accordance with some embodiments of the present invention, the boards are connected by a twistable connecting element.

Furthermore, in accordance with some embodiments of the present invention, the caster is limited to rotate within a sector of predetermined angle.

Furthermore, in accordance with some embodiments of the present invention, the caster is limited to rotate within the sector of predetermined angle by a protrusion in the shaft.

Furthermore, in accordance with some embodiments of the present invention, there is provided a skateboard comprising a support surface and at least one multi-directional caster assemblies substantially collinearly mounted on the bottom side of the support surface, each caster assembly including a rotatable caster pivotable about a shaft that is pivotally connected to a base and that may be reoriented within a predefined conical volume.

Furthermore, in accordance with some embodiments of the present invention, there is provided a skateboard device comprising: a support surface; and at least one multi-directional caster assemblies substantially collinearly mounted on the bottom side of the support surface, each caster is limited to rotate within a sector of predetermined angle.

Furthermore, in accordance with some embodiments of the present invention, the support surface comprises a single board.

Furthermore, in accordance with some embodiments of the present invention, the support surface comprises two separate boards, and wherein said at least one multi-directional caster assembly comprises two caster assemblies, each connected to one of the two separate boards.

Furthermore, in accordance with some embodiments of the present invention, the boards are connected by a twistable connecting element.

Furthermore, in accordance with some embodiments of the present invention, the caster is limited to rotate within the sector of predetermined angle by a protrusion in the shaft.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1A illustrates a bottom view of a skateboard in accordance with an embodiment of the present invention.

FIG. 1B is a side-view of the skateboard shown in FIG. 1A.

FIG. 1C is a low perspective-view of the skateboard shown in FIG. 1A.

FIG. 2A illustrates a bottom view of a skateboard in accordance with another embodiment of the present invention.

FIG. 2B is a side-view of the skateboard shown in FIG. 2A.

FIG. 2C is a perspective-view of the skateboard shown in FIG. 2A.

FIG. 3. schematically illustrates a rod assembly used for connecting the boards of a skateboard according to embodiments of the present invention.

FIG. 4A is a perspective-view of a caster of a skateboard in accordance with embodiments of the present invention.

FIG. 4B is a side-view of the caster shown in FIG. 4A.

FIG. 5 is a perspective view of the support structure of a caster of a skateboard in accordance with embodiments of the present invention.

FIG. 6A illustrates a perspective-view of an alternative support structure of a caster in accordance with embodiments of the present invention.

FIG. 6B illustrates a top view of the support structure shown in FIG. 6A.

FIG. 7 illustrates a perspective-view of an alternative caster design for a skateboard in accordance with embodiments of the present invention.

### DETAILED DESCRIPTION OF PREFERRED EMBODIMENTS

In the following detailed description, numerous specific details are set forth in order to provide a thorough understanding of the invention. However it will be understood by those of ordinary skill in the art that the present invention may be practiced without these specific details. In other instances, well-known methods, procedures, components have not been described in detail so as not to obscure the present invention.

According with embodiments of the present invention a novel design of a caster assembly is introduced. Although it is described in conjunction with a skateboard, it is noted that the novel caster assembly according to embodiments of the present invention, may be used for wheeling other items, such as, for example, chairs, tables, boxes, furniture and other items that it is desired to render portable.

A skateboard, in accordance with embodiments of the present invention, comprises a wheel assembly mechanism which allows making turns of 180, 360 degrees and the like.

In addition, the wheels assembly mechanism of the skateboard according to embodiments of the present invention is such that the positioning state of the wheels does not limit the rider to one riding direction. More specifically, the rider may safely ride forward or backward at will.

For instance, after making a 180 degrees turn the rider may continue his/her ride forward despite the fact that the wheels may be aligned backward.

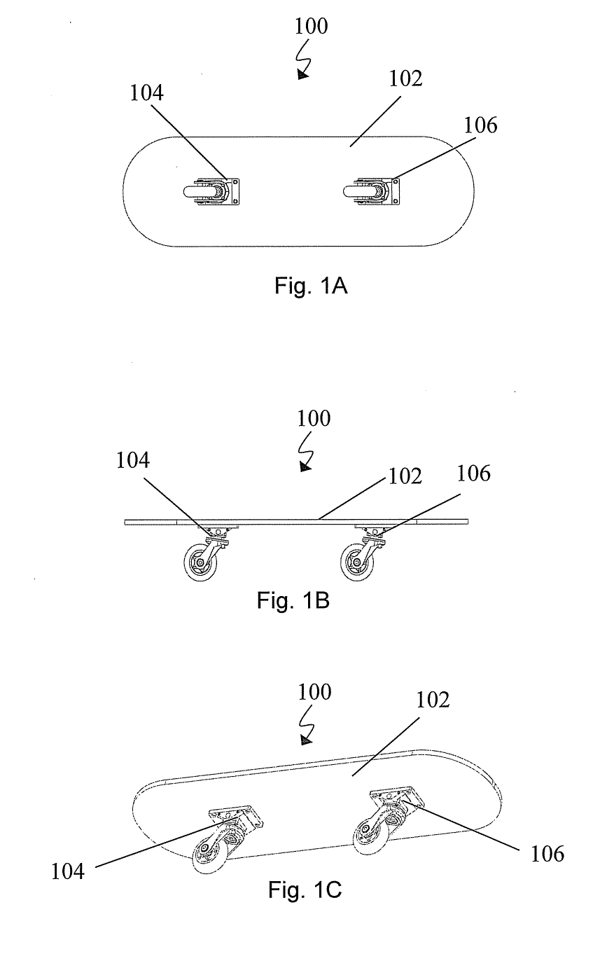

FIG. 1A illustrates a bottom view of a skateboard 100 in accordance with an embodiment of the present invention. Skateboard 100 includes a board 102, a first caster 104 and a second caster 106 mounted substantially collinearly on the bottom side of board 102. FIG. 1B is a side-view of the skateboard shown in FIG. 1A. FIG. 1C is a low perspective-view of the skateboard shown in FIG. 1A.

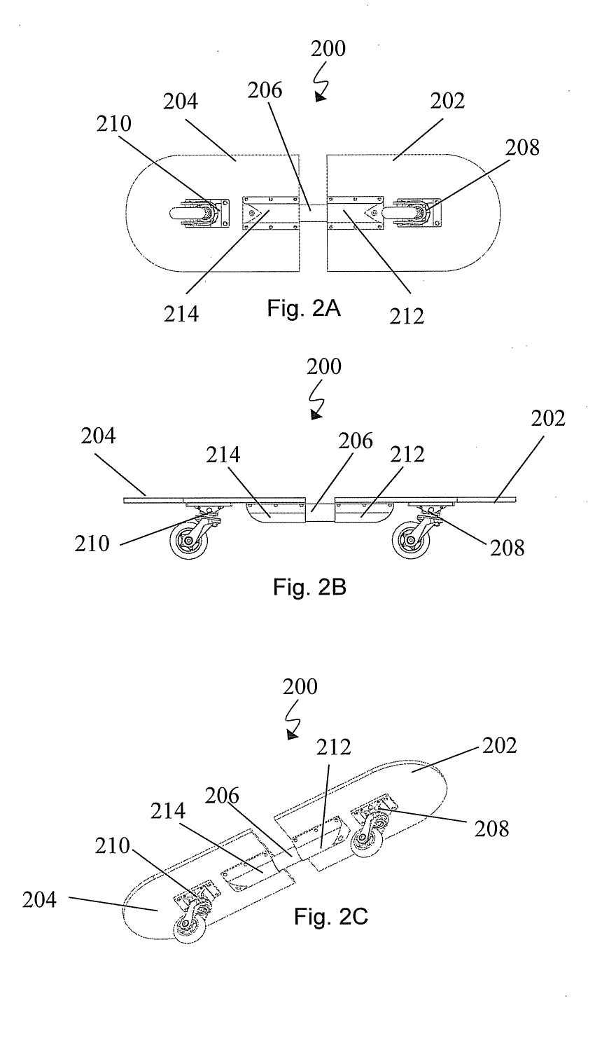

FIG. 2A illustrates a bottom view of a skateboard 200 in accordance with another embodiment of the present invention.

Referring now to FIG. 2A illustrating a plan-view of the bottom side of a skateboard 200 in accordance with embodiments of the present invention. FIG. 2B is a side-view of the skateboard shown in FIG. 2A. FIG. 2C is a perspective-view of the skateboard shown in FIG. 2A.

Skateboard 200 includes a first board 202 and a second board 204, a first caster assembly 208 mounted on the bottom side of board 202 and a second caster assembly 210 mounted on the bottom side of board 204.

Skateboard 200 also includes rod 206, fastening means 212 and fastening means 214 for fastening rod assembly 206 to boards 202 and 204 or more specifically, for interconnecting boards 202 and 204 wherein the distance kept between board 202 and board 204 is determined by the length of rod assembly 206.

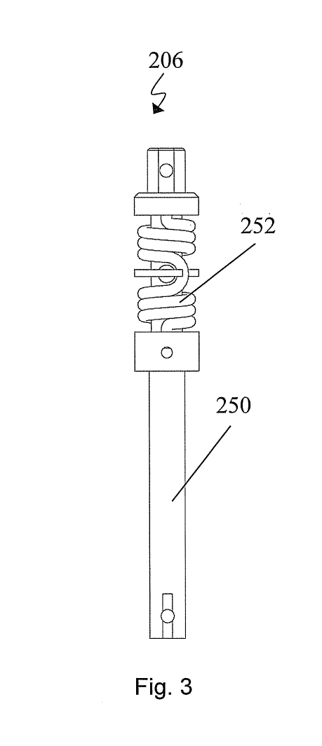

Referring now to FIG. 3 schematically illustrating rod assembly 206. To prevent it from bending, rod assembly 206 includes rod 250 typically made of a rigid material such as steel and the like.

Rod assembly 206 also includes elastic twisting element 252 which can be made, for example, from an elastic material such as a tough rubber, metal spring and the like. Twisting element 252 can be twisted upon application of a twisting force and restores to its original shape when the force is removed.

Therefore, an integrated structure such as rod assembly 206 allows the rider to slightly twist board 202 and board 204 (to opposite) sideways when he/she makes a turn.

As mentioned above, the wheels used in accordance with embodiments of the present invention are caster-type wheels which automatically swivel to align themselves to the direction from which they are pushed.

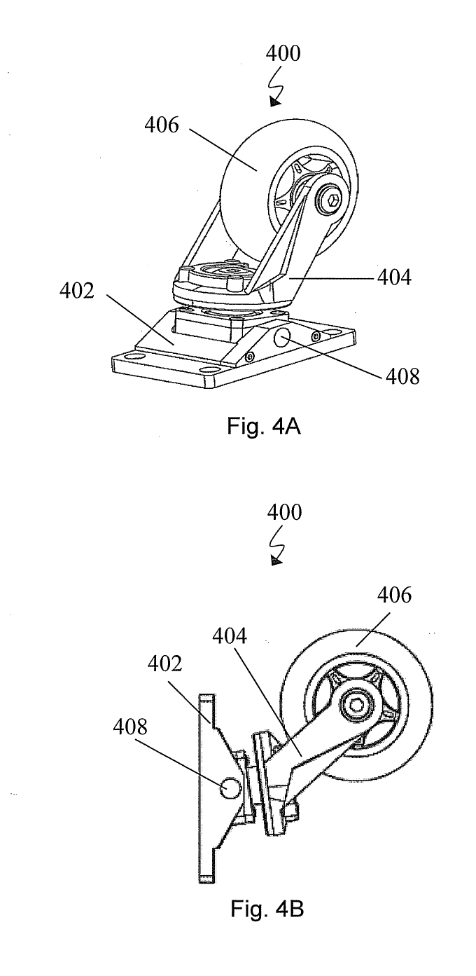

Referring now to FIG. 4A which is a perspective-view of a caster 400 in accordance with embodiments of the present invention. As seen in the figure, caster assembly 400 includes a support structure 402 attached to the board, a forked support 404 pivotally connected to support structure 402 and a wheel 406 connected to the distal end of forked support 404.

Caster assembly 400 is designed in such a way that forked support 404 can rotate 360 degrees. In addition, to better control the alignment of the wheel or more specifically, to assist in keeping the wheel aligned either forwards or backwards (i.e., to prevent the wheel from sliding to the sides), forked support 404 is pivotally attached to hinge 408 and is partially rotatable about hinge 408.

Referring now to FIG. 4B illustrating a side-view of caster assembly 400. As seen, hinge 408 is mounted within support structure 402.

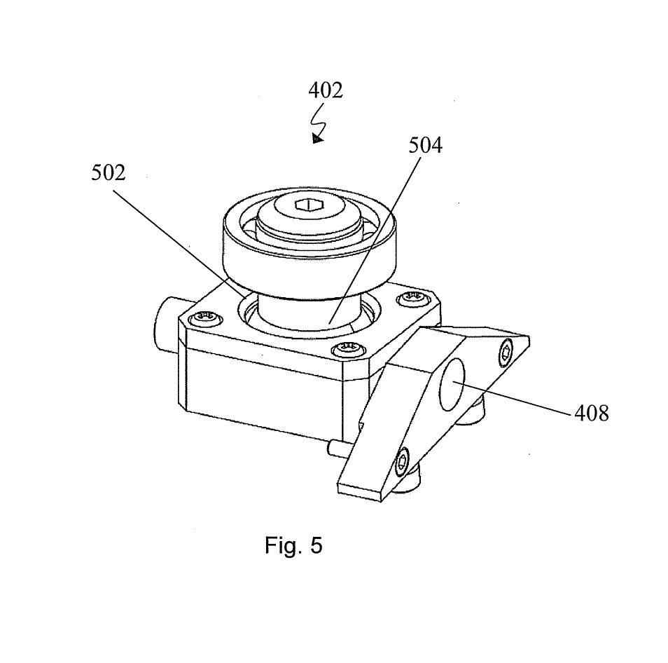

Referring now to FIG. 5 which is a perspective view of support structure 402 in accordance with embodiments of the present invention.

As seen in the figure, support structure 402 defines an aperture 502 circular in shape for the rotatable reception of shaft 504 that is connected to the roller forked support as seen in FIGS. 4A and 4B, allowing caster 406 (se FIGS. 4A, 4B) to pivotally swivel about the shaft.

The position of shaft 504 within aperture 502 depends on how the exerted weight is distributed on the skateboard. For instance, if the rider positions his/her leg on the top right side of the skateboard, shaft 504 would be situated in an opposite position (bottom-left side of aperture 502) within aperture 502.

Furthermore, when the rider shifts his/her weight on the skateboard, shaft 504 may freely rotate within aperture 502 and situate again in a specific location within aperture 502 according to the new position of the rider on the skateboard, so as to be conically reoriented.

Such mechanism allows the rider to manipulate and control the wheels and to continue his/her ride to whichever direction he/she desires regardless of the position of the wheels at any given time. In other words, the skateboard is designed in such a way to allow the rider to use his/her body weight to continuously manipulate and align the wheels as he/she desires.

An alternative oval aperture, according to embodiments of the present invention, may further assist in keeping the wheel aligned in the forward or backward direction or more specifically may prevent the wheels from sliding sideways.

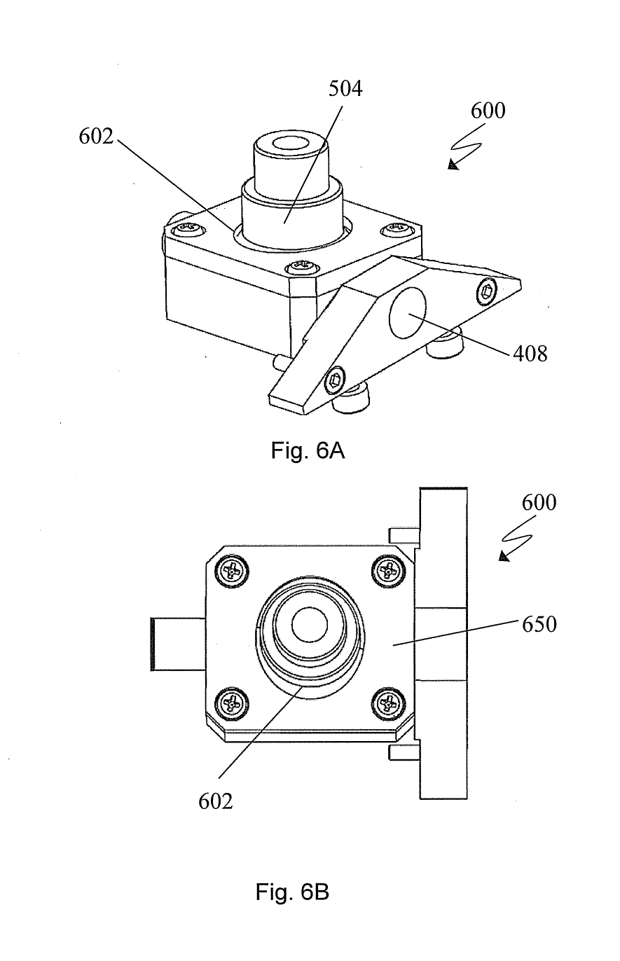

Referring now to FIG. 6A illustrating a support structure 600, in accordance with embodiments of the present invention. As seen in the figure, support structure 600 defines an elliptically-shaped aperture 602 for the rotatable reception of shaft 504.

Referring now to FIG. 6B illustrating housing structure 650 of support structure 600. The figure clearly shows that aperture 602 is elliptic in shape.

An alternative caster design in accordance with embodiments of the present invention which limits the degree of rotation of the forked support is described below.

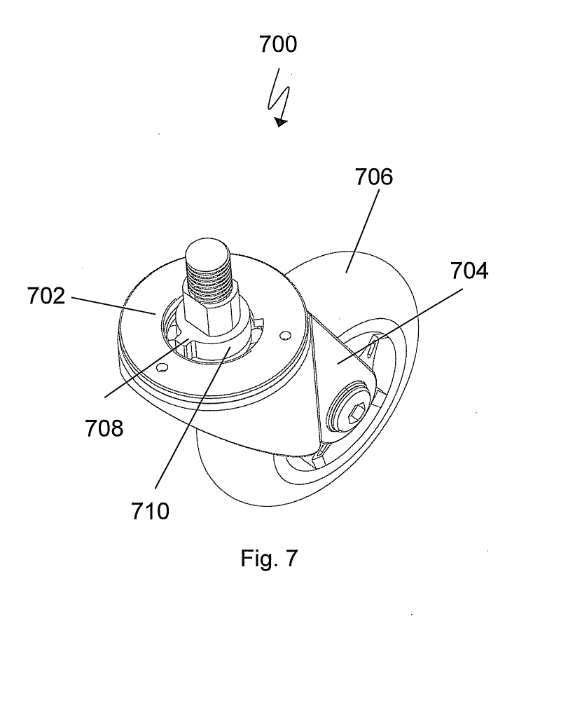

Referring now to FIG. 7 illustrating a perspective-view of caster 700 in accordance with embodiments of the present invention.

Caster assembly 700 includes a support structure 702, a roller forked support 704 pivotally connected to support structure 702 and a wheel 706 connected to the distal end of forked support 704.

As can be seen, support structure 702 consists of protrusion 708 for limiting the rotation of forked support 704 to rotations within a predetermined angular sector (in the example shown in this figure, some 280 degrees, but other angular limitations may apply too).

Caster assembly 700 may be used in conjunction with a support structure, such as shown in FIGS. 4A-6B, and may alternatively be fixedly connected to the bottom surface of the skateboard.

It should be noted that protrusion 708 can be situated anywhere else across the circumference of cylindrical element 710 for limiting the rotation of roller forked support 704 to rotations of various degrees other than 280 degrees.

It is noted that a skateboard according to some embodiments of the present invention may include a single multi-directional caster assembly. In some embodiments of the present invention two such skateboards are provided and a rider may attach each board to one of his/her feet, or attach one board to one foot only leaving the other foot free.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

1. A multi-directional caster assembly comprising a rotatable caster pivotable about a shaft that is pivotally connected to a base and that may be reoriented within a predefined conical volume.

2. The caster assembly as claimed in claim 1, comprising a support structure, wherein the shaft includes a forked support pivotally connected to said support structure on which the cater is rotatably mounted, wherein the support structure includes an aperture confining the shaft to move within the aperture.

3. The caster assembly as claimed in claim 2, wherein the aperture is circular.

4. The caster assembly as claimed in claim 2, wherein the aperture is oval.

5. The caster assembly as claimed in claim 1, incorporated in a skateboard.

6. The caster assembly as claimed in claim 5, wherein the skateboard comprises a support surface.

7. The caster assembly as claimed in claim 6, wherein the support surface comprises a single board.

8. The caster assembly as claimed in claim 6, wherein the support surface comprises two separate boards, wherein the caster assembly is attached to the bottom of each board.

9. The caster assembly as claimed in claim 8, wherein the boards are connected by a twistable connecting element.

10. The caster assembly as claimed in claim 1, wherein the caster is limited to rotate within a sector of predetermined angle.

11. The caster assembly as claimed in claim 10, wherein the caster is limited to rotate within the sector of predetermined angle by a protrusion in the shaft.

12. A skateboard comprising a support surface and at least one multi-directional caster assemblies substantially collinearly mounted on the bottom side of the support surface, each caster assembly including a rotatable caster pivotable about a shaft that is pivotally connected to a base and that may be reoriented within a predefined conical volume.

13. A skateboard device comprising:
a support surface;
at least one multi-directional caster assemblies substantially collinearly mounted on the bottom side of the support surface, each caster is limited to rotate within a sector of predetermined angle.

14. The device as claimed in claim 13, wherein the support surface comprises a single board.

15. The device as claimed in claim 14, wherein the support surface comprises two separate boards and wherein said at least one multi-directional caster assembly comprises two caster assemblies, each connected to one of the two separate boards.

16. The device as claimed in claim 15, wherein the boards are connected by a twistable connecting element.

17. The device as claimed in claim 13, wherein the caster is limited to rotate within the sector of predetermined angle by a protrusion in the shaft.
